(19) United States
(12) Patent Application Publication
(10) Pub. No.: US 2018/0319173 A1
(43) Pub. Date: Nov. 8, 2018

(54) INK RESERVOIR WITH BACK PRESSURE SYSTEM

(71) Applicant: SICPA HOLDING SA, Prilly (CH)

(72) Inventor: Silvano TORI, Chiaverano (IT)

(21) Appl. No.: 15/577,589

(22) PCT Filed: Mar. 31, 2016
(86) PCT No.: PCT/EP2016/057053

§ 371 Date: Nov. 28, 2017

(30) Foreign Application Priority Data
May 28, 2015 (EP) 15169594.7

(51) Int. Cl. B41J 2/175

(52) U.S. Cl. CPC B41J 2/17556; B41J 2/17559; B41J 2/17523; B41J 2/17513

(57) ABSTRACT

The present invention provides an ink reservoir 5 including an ink supply interface 2, a duct 3 forming a connection between the ink reservoir 5 and the ink supply interface 2 and a back pressure system. The back pressure system comprises an anisotropic fibrous member 9 for retaining solvent-based ink located within the ink reservoir 5, wherein the fibrous member 9 is established by a plurality of fibers 8. At least some of the fibers are facing the duct 3 leading to the ink supply interface 2.

### FIELD OF THE INVENTION

The invention relates to an ink reservoir for a printer, in particular to a back pressure system of an ink reservoir containing solvent based ink and an inkjet cartridge comprising such a reservoir.

### BACKGROUND ART

The precise control of ink flowing out of an inkjet cartridge is one of the essential prerequisites for achieving high-end quality prints with an ink-jet printer. One system that assists in providing this amount of control of the ink flow is the backpressure system, which creates a negative pressure within the ink reservoir. The negative pressure in the ink reservoir prevents any unintentional leakage of ink. Otherwise, such a leakage may occur when the printhead using the ink is idle or the ink reservoir is exposed to sudden accelerations.

One backpressure system known in the art employs an open cell foam to create negative pressure within the reservoir caused by the capillary effect of the foam's network of pores.

These open cell foams such as a foam made of polyurethane polyether generally have a uniform elasticity in all three spatial dimensions. As a result, they can adapt closely to their surroundings in all directions when being installed in an ink reservoir of a printer. It is desired to achieve a close contact between components situated in the flow path of the ink contained in the reservoir through an outlet since the creation of a negative pressure within the reservoir may lead to an accumulation of air flowing upstream. In other words, if there is sufficient space between two components along the flow path of the ink, a bubble of air may form, which subsequently hinders or even stops the flow of ink.

However, as the inventors realized during the development of an ink reservoir for a solvent based ink, the material of the foam absorbs the solvent causing swelling of the material over time. Since the volume of the material of the foam increases within the set volume of the reservoir, the volume of the voids, i.e. the pores, decreases. This results in a reduced accessible capacity of the ink reservoir as well as a reduced capillary action. Further, an increased load on the reservoir walls has been observed, which affects the dimensional stability of the ink reservoir. This may cause damage to the reservoir's walls and adjacent components or, in case of an ink reservoir being part of a replaceable ink cartridge, may jam the cartridge within a printer. At worst, the swelling causes fracture of the reservoir's material. Thus the structure of an ink reservoir initially intended for water based ink has to be strengthened accordingly.

The structure of an inkjet cartridge for water based ink is, for example, described in U.S. Pat. No. 8,480,217 B2. The reservoir contains porous material for absorbing water-based ink made of a compressible foam and an incompressible fiber material, wherein most of the reservoir's space is occupied by the foam. The incompressible fiber material is placed above the foam and provides the empty space between the porous material and the inner cartridge walls needed for reliable venting.

Another system apt to withstand solvent based ink is a mechanical spring system acting on a flexible ink reservoir such as a bag. In this system, mechanical springs are fixed to the external bag surface so that forces exerted in opposite directions by the springs are able to enlarge the internal bag volume, which results in the desired backpressure. However, these systems are both complex in design as well as hard and costly to manufacture due to the high number of small parts necessary to establish such a system. Also, the complex structure and the movability of the system to adapt the volume of the flexible ink reservoir makes the system susceptible to wear and, thus, malfunctions are likely to occur over time.

EP 1 258 363 A1 discloses an ink tank in which an ink holding member is inhibited from being excessively deformed. Two holding members are provided within the ink tank which have different capillaries and may be foam or fiber materials.

### SUMMARY OF THE INVENTION

Consequently, there is a need for a back pressure system that is solvent resistant and provides the negative pressure required to prevent any unintentional leaking of ink out of the reservoir. It is another objective of the present invention to provide a cheap and effective solution that is able to accurately fit into the space of the ink reservoir and does not develop dimensional instabilities over time when being in contact with solvent based ink. It is also desirable that the back pressure system allows for a retrofit of existing reservoir designs.

In order to fulfill these objectives, the present invention provides an ink reservoir including an ink supply interface, a duct forming a connection between the ink reservoir and the ink supply interface and a back pressure system. The back pressure system comprises an anisotropic fibrous member for retaining solvent-based ink located within the ink reservoir, wherein the fibrous member is established by a plurality of fibers. At least some of the fibers are facing the duct leading to the ink supply interface.

The new solvent resistant fiber based structure of the fibrous member provides the backpressure needed to keep the ink within the reservoir while the printhead is idle. Since the anisotropic fibrous member withstands solvent-based ink, the back pressure system of the present invention is dimensionally stable. Consequently, the back pressure system does not experience the variation in the negative pressure described above in relation with back pressure systems for water-based inks that are exposed to solvent-based ink. As a result, the pressure inside the ink reservoir stays below the pressure outside the ink reservoir due to the capillary forces acting between and/or within the solvent resistant fibers. On the one hand, this prevents ink leaking out of the ink reservoir during time periods, in which there is no demand for ink, and on the other hand allows the ink to remain within the ink reservoir over extended periods of time. Particularly the latter makes the system according to the invention applicable not only for ink cartridges but also for permanently installed ink reservoirs within an ink-jet printer. Moreover, the lack of swelling makes all the ink within the reservoir accessible for use.

In addition, the back pressure system of the present invention preserves the simple structure of water-based systems and can even be used to retrofit existing reservoirs by simply replacing the foam with the fibrous member of the present invention as long as the remaining parts withstand the solvent used to store and supply the ink particles.

The skilled person will understand from this description that the solvent of the solvent-based ink refers to solvents such as organic solvents but does not include the use of water as a solvent. Solvent resistant according to the present invention refers to an approximately stable behavior of the ink reservoir's components and their material properties when being exposed to solvent-based ink.

The fibrous member has anisotropic material properties since the fibers are generally aligned in parallel to each other. As defined above, at least some of the fibers are facing the duct leading to the ink supply interface. Consequently, the longitudinal axis of these fibers lead the ink stored therein towards said duct.

The ink supply interface is generally configured according to the type of ink reservoir. More specifically, if the ink reservoir forms part of an ink cartridge, the ink supply interface is designed as a detachable connection, which facilitates the replacement of an empty ink cartridge with a new one. However, if the ink reservoir is permanently installed as part of the printer such as a refillable reservoir for the printhead, the ink supply interface will be preferably designed to establish a more permanent connection with the printhead. Finally, it is also possible that the ink supply interface comprises the printhead for the ink stored within the ink reservoir.

The fibrous member provides in a preferred embodiment the major share of the ink reservoir's storage capacity for solvent-based ink, preferably at least 80%, more preferably at least 90% and most preferred at least 95%.

Providing the major share of the storage capacity by the fibrous member ensures a stable negative pressure caused by the capillary action of the fibers and a high dimensional stability. Also, providing the storage capacity of the ink reservoir in this manner ensures that there is no shift of the solvent-based ink within the reservoir which may potentially affect the generally sudden movements of the printhead due to forces of inertia. In other words, by storing the major share of the ink's weight in the fibrous member, the point of gravity of the ink stored in the reservoir does not significantly shift and is, thus, especially advantageous for ink reservoirs that move together with the printhead. Consequently, the higher the share of ink stored within the fibrous member, the better can the kinetic behavior of the ink reservoir as well as the capillary force be controlled.

In a particularly preferred embodiment of the present invention, the fibrous member is formed by a plurality of fiber layers made of fibers that are attached to each other.

This particularly preferred embodiment allows for a control of the capillary effect when designing and fabricating the fibrous member. One of the reasons for being able to determine the negative pressure exerted by the fibrous member within the ink reservoir so accurately lies within the ability to specifically design the cross section of the fibrous body. In contrast to the foam body used in the prior art, the cross-section of the fibrous body is generally uniform along the longitudinal length of the fibers. In other words, this configuration of the fibrous body provides an accurate tuning of the capillary effect, which creates the back pressure needed to keep the ink within the reservoir.

In another embodiment of the present invention, each fiber layer has a maximum thickness corresponding to two to three times the diameter of one fiber.

Keeping the thickness of each layer within this range enhances the control when adjusting the amount of capillary force exerted by the fibrous member since the layout or arrangement of the fibers is more predictable. The predictability of the fiber arrangement increases with decreasing thickness of the layers.

In yet another embodiment of the present invention, at least some of the fibers of the fibrous member are polyethylene polypropylene fibers, the polyethylene preferably forming an outer sheath and the polypropylene an inner core of the fiber.

It has been found that materials made from polyethylene polypropylene have a good resistance against and compatibility with the solvents used in the solvent-based ink. Preferably, all fibers are made of this material.

Further, forming the fibers with an outer sheath of polyethylene and an inner core of polypropylene has the advantage that contiguous fibers can be easily joined by heat without significantly affecting the fiber's integrity since polyethylene has a lower melting point than polypropylene.

The ink reservoir of a further embodiment also comprises a filter that is situated between the fibrous member and the duct.

The filter basically prevents any particles or debris having a size from entering that may occlude the duct or the nozzles of the printhead. Such particles may for example be detached fibers from the fibrous member or agglomerations of ink particles.

The filter is preferably placed directly over the mouth of the duct that leads to the ink supply interface. Thus the filter lies on the ink flowpath and is in fluid communication with the printhead.

In another embodiment, the filter of the reservoir comprises a mesh made of strands.

The properties of such a filter can be easily adapted to the requirements for a reliable flow of ink. More specifically, the outer dimensions of the filter can remain the same, wherein by adjusting the dimensions of the strands' cross section, profile and density, the flow characteristics of the filter may be significantly varied.

In one embodiment, the strands of the filter are made of metal. Metal has the advantage to be highly resistant against any of the solvents used in solvent-based ink, the reservoir of the present invention is designed for.

The ink reservoir of a further embodiment also comprises an adjustment member located between the fibrous member and the duct.

The function of the adjustment member is to improve the fit of the fibrous member in the cartridge, particulary on the side of the duct or filter leading to the printhead. By employing the adjustment member, the higher stiffness of the fiber based structure in the longitudinal direction of the fibers compared to the transverse direction can be locally adapted so that there is a continuous flowpath for the ink.

In other words, the continuous flowpath is established by a close contact of the components along the flowpath so that there is no dead space in between that may serve as a collection point for air creating an air bubble that may obstruct the flow of ink to the printhead. Air bubbles may enter the flow path for the ink in the reverse direction due to the negative pressure within the ink reservoir.

Particularly, if a filter is installed in front of the entrance of the duct, there is an uneven surface present compared to the otherwise relatively smooth wall surface on the inside of the ink reservoir. The rough or wavy surface of the filter and the relatively high stiffness of the fibres in their longitudinal direction makes it hard for the fibrous member to establish a direct contact with the filter's surface facing the face sides of the fibers. The rigidity of the fibrous body in the longitudinal direction of the fibers makes it also hard to close any gaps between the filter and the fibrous member caused by an incomplete fit by simply pressing the fibrous member against the filter. Here, the adjustment member serves as a flexible interface between the fibers of the fibrous member and the surface of the filter. Consequently, the adjustment member is preferably in direct contact with both the filter and the face sides of the fibers.

Without a filter present, the adjustment member still has the advantage that it redirects the flowpath of the ink out of the fibrous member in areas that do not directly face the duct leading to the ink supply interface of the ink reservoir. Otherwise, the face sides of the fibers may partly directly contact the inner wall of the ink reservoir, which can significantly increase the flow resistance for the ink drawn out of the fibers. As a result, it may become harder to empty out the ink reservoir.

In a preferred embodiment, the adjustment member comprises a compressible foam.

Although using a compressible foam for the whole ink reservoir has at least some of the negative effects described in detail above, solely forming the adjustment member with a compressible foam makes use of its isotropic properties where they are needed. On the one hand this foam easily redirects the flowpath of the ink at the face side of the fibrous member 9a towards the duct or the filter and on the other hand the compressible properties facilitate a smooth transition from the face sides of the fibers to the duct or the filter.

Further, the compressibility of the foam may be used to fine-tune the capillary forces within the ink reservoir by compressing the adjustment member accordingly. The adjustment member may also fulfill the functionality of a filter so that it may complement or be an alternative to the above-mentioned filter.

In order to achieve any of these objectives, the minimum thickness of the adjustment member may be in the magnitude of two to five times the maximum distance between the face sides of two of the fibers furthest away from each other, which are part of the fibrous member. On the other hand, the thickness is preferably be chosen to be high enough for reliably redirecting the flowpath for the ink leaving the fibrous member. In any case, the storage capacity of the adjustment member is preferably negligible in comparison to the storage capacity of the fibrous member.

Consequently, in a preferred embodiment, the volume of the adjustment member in relation to the fibrous member is less than 20% preferably less than 10% and most preferably less than 5%.

In another preferred embodiment, the adjustment member extends along the complete face side of the fibrous member 9a directed towards the duct.

This embodiment is particularly advantageous if the adjustment member is intended for redirecting the ink flow out of the fibrous member towards the filter or the duct since the mouth of the duct does generally not extend over a complete side face of the ink reservoir. An adjustment member that redirects the flowpath also facilitates the complete emptying out of the ink reservoir.

In an embodiment of the present invention, the ink reservoir further comprises a venting port.

The venting port has the advantage of stabilizing the negative pressure originating from the backpressure system. As explained above, in proximity of the ink supply interface, the ink pressure should be lower than the atmospheric pressure to avoid any ink dropping out due to hydrostatic pressure. However, the volume of ink consumed during operation of the printer also creates a negative pressure within the reservoir. In order to avoid the negative pressure reaching an undesired level, the reservoir preferably comprises a venting port, which puts the inner part of the reservoir, just above the fiber, in communication with the atmospheric pressure. If the negative pressure inside the cartridge increases, the port causes some air to enter the reservoir in order to reestablish the desired level of negative pressure by basically eliminating the effect of ink leaving the reservoir on the interior pressure of the reservoir. In other words, the port ensures that the negative pressure within the reservoir is preferably only caused by the backpressure system.

In a preferred embodiment, the fibrous member is for solvent-based ink, which includes at least one solvent selected from the group comprising alcohols such as Ethanol and Isopropyl alcohol (IPA), ketones such as methyl isobutyl ketone (MIBK) and methyl ethyl ketone (MEK), sulfoxides such as dimethyl sulfoxide (DMSO), amides such as dimethylformamide (DMF), and xylenes.

Thus, the fibrous member is resistant against at least one, any or any appropriate combinations of said solvents, which are usable for solvent based inks according to the present invention. This allows for an optimum choice of solvent for the respective ink particles, which enhances the quality of the prints achieved with this ink.

The present invention additionally provides an inkjet cartridge comprising an ink reservoir according to one of the embodiments previously described.

A replaceable inkjet cartridge facilitates a fast and easy replacement of an empty cartridge with a new one. In addition, the requirements for solvent resistance are less then in case of a permanently installed ink reservoir. More specifically, in such a cartridge, the adjustment member may be established by a foam that still experiences a certain amount of swelling. However, the swelling does not significantly influence the function of the ink reservoir in providing a printhead with ink since it's volume share compared to the volume share of the fibrous member is relatively low as previously described.

### SHORT DESCRIPTION OF THE DRAWINGS

The present invention will be described for the sake of better understanding by way of examplary embodiments. These embodiments may be best understood by taking the following drawings in consideration. Within the figures of these drawings, same reference numerals are used for features that are identical or have an identical or similar function. In these figures,

FIG. 1 shows a cross section of an inkjet cartridge;

FIG. 2 shows a three-dimensional view of the prior art inkjet cartridge shown in FIG. 1 with partly installed foam members that form the back pressure system of the cartridge;

FIG. 3 shows a side view of a layer of the fibrous member according to the present invention;

FIG. 4 shows an assembled fibrous member, which forms the back pressure system of the present invention;

FIG. 5 shows an inkjet cartridge according to the present invention with partly installed fibrous members.

FIG. 6 shows in FIG. 6a for the sake of clarity a schematic cross-section of an ink supply interface belonging to an ink cartridge derived from an x-ray image of the ink supply interface of an inkjet cartridge shown in FIG. 6b;

FIG. 7 shows another embodiment of an inkjet cartridge according to the present invention that comprises an adjustment member;

FIG. 8 shows an exemplary embodiment of a filter that may be used in the ink reservoir according to the invention at the entrance of the duct, which leads to the ink supply interface.

### DESCRIPTION OF PREFERRED EMBODIMENTS

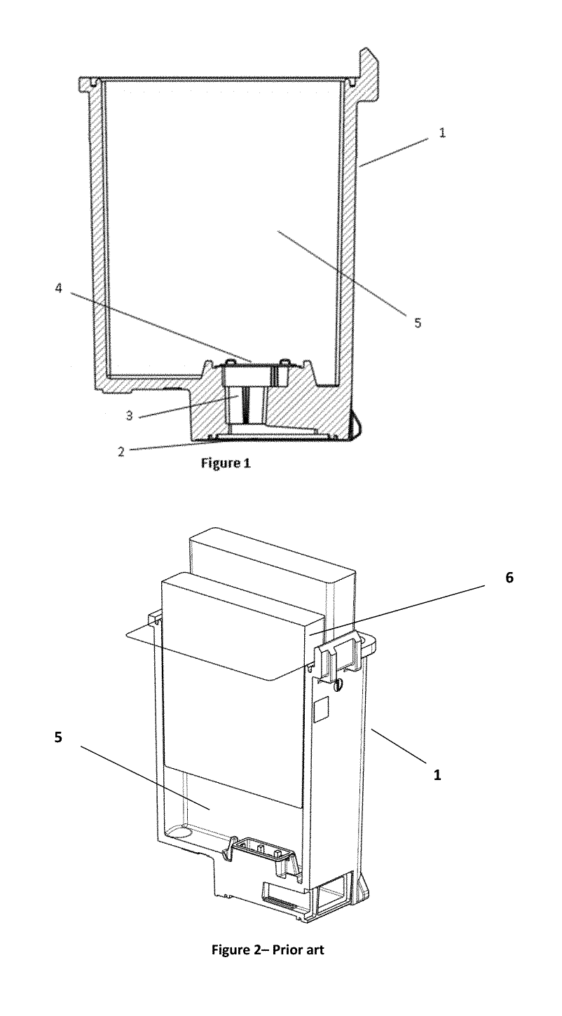

The inkjet cartridge 1 shown in FIG. 1 comprises an ink reservoir 5, a filter 4, a duct 3 and an ink supply interface 2. The ink supply interface 2 may be formed as a printhead ejection assembly, which delivers ink droplets for printing on demand.

The ink reservoir 5 shown in FIG. 1 has a configuration that allows the ink contained within the reservoir 5 to leak out of the ink supply interface 2 due to hydrostatic pressure exerted by the ink itself. The same effect may also occur during handling or operation of the inkjet cartridge 1 that expose the cartridge to sudden accelerations.

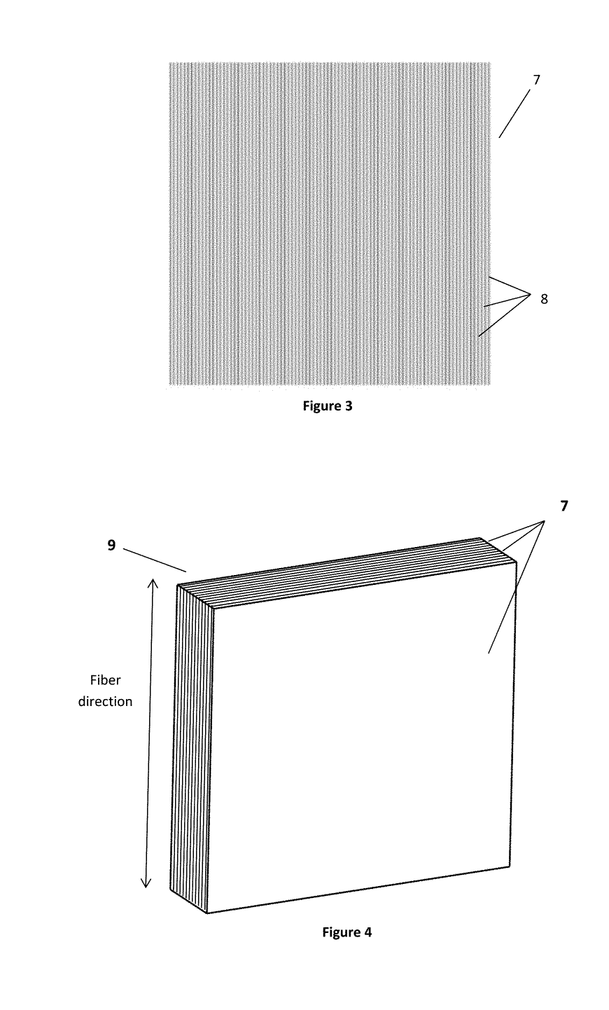

As described above, this leakage can be avoided by including a back pressure system within the ink reservoir 5 that provides a negative pressure that retains the ink within the ink reservoir 5. A common back pressure system known from the prior art is shown in FIG. 2 and consists of a foam 6 that is inserted into the reservoir. The open pores of the foam create the negative pressure necessary to hold back the ink. One material typically used to fabricate the foam member is polyurethane polyether.

The prior art inkjet cartridge 1 shown in FIG. 2 has two ink reservoirs 5, each containing a compressible porous foam 6 for creating aforementioned negative pressure. Multiple ink reservoirs 5 in one inkjet cartridge 1 are generally used for different inks. However, as the inventors observed, when using solvent-based ink, which employs a different medium than water for containing the ink particles, the foam material is prone to be heavily modified and damaged due to the exposure to the solvent. The swelling occurring during this adverse process changes the properties of the foam and causes pressure on the surroundings that may even damage the reservoir's body itself.

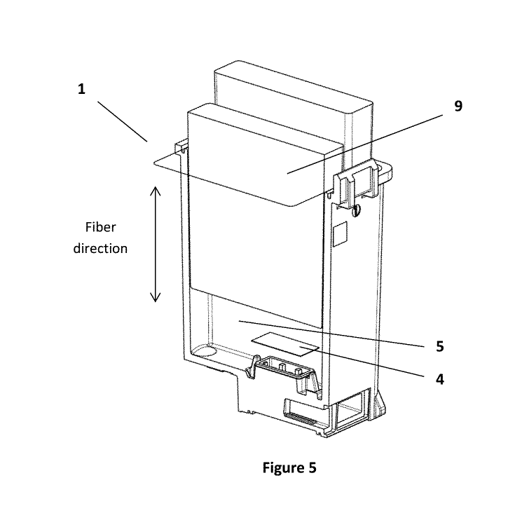

Therefore, the present invention uses a different body, which also generates the negative pressure by capillary action. As shown in FIGS. 3 and 4, the body of porous foam 6 shown in FIG. 2 is replaced by a fibrous member 9, which is constructed of fiber layers 7 that in turn are made of solvent resistent fibers 8.

The fibers 8 are preferably made of polyethylene-polypropylene, which has a good compatibility with the solvents used in solvent-based inks such as Ethanol and IPA (alcohol-based inks), MIBK and MEK (ketone-based inks), DMSO (sulfoxide-based inks) and DMF (amide-based inks). On the other hand, these fibers are less compatible with xylene-based inks so that this solvent is preferably not used with said fibers 8.

The fibers 8 may comprise an external sheath of one polymer and an internal core of another material. In this case, a capillary effect occurs between the fibers since the fibers are not hollow. Further, if the material of the external sheath has a lower melting point than the core, heating possibly complemented with the application of external pressure provides an easy way to join the adjacent fibers to form the fibrous member 9. For example, in case of the aforementioned material mix, the external sheath is preferably made of polyethylene and the core of polypropylene, the latter having a higher melting point than the former.

For creating a sufficient level of negative pressure, the fibers have a diameter of preferably 10 to 30 microns, more preferably 15 to 25 microns and most preferred 20 microns. These dimensions provide the space necessary for the capillary effect to be established and at the same time cause negative pressure to be within a desired range or to achieve a desired value.

As shown in FIG. 3, the fibers 8 of a layer 7 are arranged adjacent and approximately parallel to each other. The same applies to the fiber layers 7, which are stacked on top of each other to form the three-dimensional shape of the fibrous member 9 (FIG. 4). It noted that FIG. 3 is a schematic idealized drawing, in which the fibers look like parallel “sticks”. In reality they show a certain irregularity or waviness. Therefore, the real fiber arrangement is somewhat less strict as the one depicted in the figure. The preferred layer thickness of one layer preferably lies within a range of twice to three times the diameter of a fiber 8.

This arrangement keeps any irregularities when attaching the fibers 8 to each other as low as possible. For the sake of explanation, if the thickness of a fiber layer 7 is about a diameter of one fiber, the fiber layer 7 basically consists of a neatly arranged row of fibers as shown in FIG. 3. In case of a fiber layer with a maximum thickness of twice the diameter of an average fiber may result in two strictly arranged rows of fibers that may also comprise sections, in which fibers are arranged in a staggered offset manner. These irregularities increase with an increasing thickness of a layer. It has been found that keeping a layer's thickness within aforementioned range is a practical and cost efficient way to produce the individual fiber layers 7.

As described above, it is at least the small space between adjacent fibers produces the capillary properties of the fibrous member 9. This space is preferably created by using fibers with a cross section, such as a circular cross section that does not allow an arrangement of the fibers without any space in between the fibers as seen in a cross section transverse to the longitudinal direction of the fibers. Moreover, it is possible to use hollow fibers to complement the capillary effect existing between adjacent fibers.

As depicted in FIG. 5, the dimensions and form of a fibrous member 9 according to the present invention is similar to the dimensions and form of a foam 6 as shown in FIG. 2. Thus, an ink reservoir 5 may simply be made solvent resistant by inserting the fibrous member 9 into the reservoir 5 instead of the foam 6 in order to enable the ink reservoir 5 to carry solvent-based ink. Further, FIG. 5 shows an inkjet cartridge 1 according to an embodiment of the present invention containing two ink reservoirs 5. Preferably, these 2 ink reservoirs 5 are identical. However, the skilled person will appreciate that one of the reservoirs 5 may employ a back pressure system according to the invention, whereas in another reservoir of the same inkjet cartridge 18 a prior art back pressure system for water based ink may be installed. It will be appreciated by the skilled person that the cartridge may also only comprise one ink reservoir 5.

FIG. 5 also illustrates the general fiber direction of the fibers 8, which form the fibrous member 9. The anisotropic elasticity of the fibrous member 9 resulting from this configuration, reduces the adaptability of the fibrous member 9 at the face side of the fibrous member 9a, i.e. the ends of the fibers, compared to the adaptability of the fibrous member 9 to the inside of the ink reservoir 5 in a direction perpendicular to the longitudinal direction of the fibers 8. In other words, the stiffness of the fibrous member 9 along the direction of the fibers is significantly higher than the stiffness in the other two dimensions. Consequently, the geometry of the face sides of the fibrous member 9 has to be adjusted in order to fit to the interior geometry of the ink reservoir 5.

Although the higher rigidity along the fiber direction generates difficulties in coupling between the fibrous member to subsequent components on the flowpath of the ink, the fiber orientation of the fibrous member 9 has this preferred direction of the fibers 8 for hydraulic reasons. More specifically, the preferred direction should be oriented towards the duct 3 or, if present, the filter surface of a filter 4 for an optimum capillary effect exerted by the fibers 8. In other words, the fibers are preferably arranged perpendicular to the filter surface or the plane of the duct's mouth opening towards the interior of the reservoir.

However, if no close contact between the components along the flowpath of the ink out of the ink reservoir 5 is established, there may be severe drawbacks for the functionality of the printer, which holds the ink reservoir 5. More specifically, if the interface between the filter 4 and the fibrous member 9 is not as tight as possible, gas may be sucked from the perimeter instead of ink from the porous material. This effect becomes more prominent when filters of a larger size are used such as in the case of “one-inch printheads”. More specifically, the larger surface of these filters makes the coupling with the fibrous member 9 even more critical.

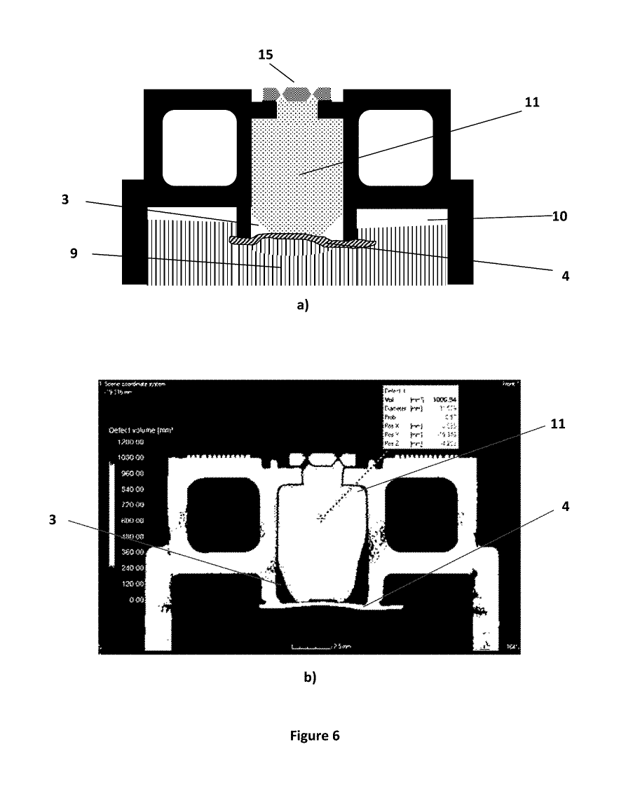

The adverse effect of insufficient contact between the filter 4 and the fibrous member 9 has been identified by the inventors using x-ray analysis and is shown in FIGS. 6a and 6b. For the sake of clarity, the original x-ray image depicted in FIG. 6b has been redrawn as a schematic as depicted in FIG. 6a. If the geometry of the fibrous member 9 is not perfectly adapted to the inner geometry of the ink reservoir 5 and the insertion force has not been able to force such an adaptation, there is a dead or void space 10 present between the inner wall of the ink reservoir 5 and the fibrous member 9 that may be filled with gas. If, in addition, the contact between the filter 4 and the fibrous member 9 is not close enough, any gas contained in the dead space 10 of the ink reservoir 5 may move along the filter's surface, causing the creation of a gas bubble 11 in the ink's flowpath that hinders and eventually stops the normal flow of ink towards the printhead 15.

One of the reasons an insufficient contact between the fibrous member 9 and the filter 4 occurs can be seen in an exemplary embodiment of the filter 4 in FIGS. 8a and 8b, namely the wavy or an uneven filter surface. In addition, the filter surface may not be perfectly planar due to the heat induced attachment process to the ink reservoir 5 and the different coefficient of thermal expansion of the filter (e. g. made of metal), the body of the ink reservoir 5 (e. g. made of a polymer) and/or the fibrous member 9 (e. g. made of a polymer).

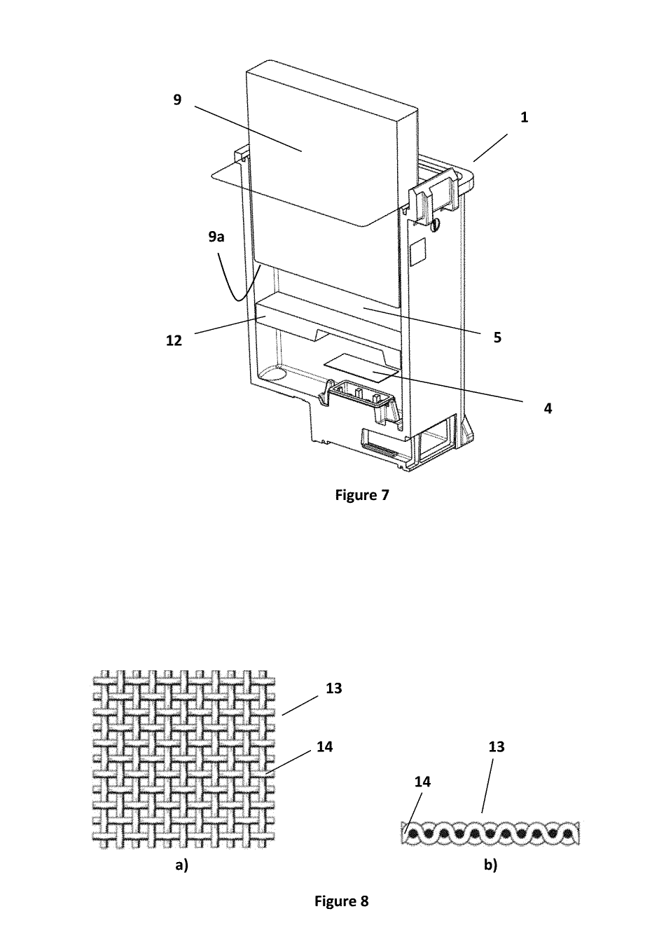

Another solution for this issue besides a geometric adaptation of the fibrous member 9 to the inner geometry of the ink reservoir 5 is the use of an adjustment member 12, as shown in FIG. 7. The adjustment member 12 is made of a highly flexible material, which is able to establish a hydraulic communication between the fibrous member 9 and the duct 3 or the filter 4. As shown in FIG. 7, the geometry of the adjustment member 12 closely matches the inner geometry of the ink reservoir 5 in the section of the ink reservoir 5, where the filter 4 and the duct 3 are provided. Although the use of an adjustment member 12 is particularly preferable when a filter 4 with an uneven filter surface is present (cf. FIGS. 8a and 8b), an adjustment member 12 may also be used for an ink reservoir 5 without a filter 4.

The material of the adjustment member 12 is preferably foam since foam is easily compressible in all three dimensions compared to the longitudinal direction of the fibrous member 9. Thus, it can closely match any discrepancies between the geometry of the fibrous member 9 and the geometry of the ink reservoir 5. This prevents the creation of a dead space 10 (cf. FIG. 6a) resulting in the negative effects detailed above.

Although the adjustment member 12 is preferably made of a solvent resistant foam, it may also be made of a foam that exhibits swelling in contact with solvent based ink as long as the volume of the foam relative to the volume of the fibrous member 9 is sufficiently small, as has been specified in more detail above. In other words, although swelling still occurs due to the non solvent resistant foam, the dimensional changes of the foam are small due to its small size relative to the fibrous member 9 or the capacity of the ink reservoir 5 so that the above explained negative effects do not significantly influence the functionality of the ink reservoir 5, if at all.

In any case, the thickness of the foam layer acting as a buffer between the fibrous member and the filter 4 or the entrance or mouth to the duct 3 should be chosen as small as possible to avoid the effect of swelling but to still fulfill the function as a buffer, and, preferably, as a redirecting means for the ink flowing out of the face sides of the fibers as described in more detail above.

Another advantage of using an adjustment member as an interface is the option to achieve a fine tuning of the capillarity of said adjustment member and, thus, the resulting capillarity of the back pressure system. More specifically, by controlling the compression caused by the fibrous member 9 against the adjustment member 12, preferably made of foam, by the degree of insertion of the fibrous member into the ink reservoir, the actual capillarity can be set to a desired value adequate for the impeccable functionality of the printer.

As can be seen in FIGS. 8a and 8b, the filter 4 is preferably formed as a mesh 13 that is in turn established by a plurality of intermeshing strands 14. The preferred material for the strands 14 or of the filter 4 is metal that is resistant to the solvent of the solvent-based ink. As described above, filters of such a configuration are easy to produce and can be tweaked according to the desired characteristics in terms of flow and the debris and particles that have to be separated from the ink passing the filter 4. Otherwise this debris or the particles may obstruct the narrow duct for the ink leading to the printhead or the printhead itself.

### REFERENCE SIGNS

1 cartridge
2 ink supply interface
3 duct (forms part of ink flowpath)
4 filter
5 ink reservoir
6 foam (prior art)
7 fiber layers
8 fiber
9 fibrous member comprising several fiber layers
9a face side of the fibrous member
10 void space adjacent to the filter
11 gas bubble obstructing the flowpath of the ink
12 adjustment member
13 filter mesh
14 strands forming the mesh
15 printhead

1. An ink reservoir including:
an ink supply interface;
a duct forming a connection between the ink reservoir and the ink supply interface ; and
a back pressure system comprising an anisotropic fibrous member for retaining solvent-based ink located within the ink reservoir, the fibrous member being established by a plurality of fibers having a fiber direction, wherein at least some of the fibers are facing the duct leading to the ink supply interface so that the fiber direction is oriented towards the duct,
wherein an adjustment member is located between the fibrous member and the duct, and
wherein the volume of the adjustment member in relation to the fibrous member is less than 20%.

2. The ink reservoir according to claim 1, wherein the fibrous member provides the major share of the capacity of the ink reservoir for solvent-based ink.

3. The ink reservoir according to claim 1, wherein the fibrous member is formed by a plurality of fiber layers made of fibers that are attached to each other.

4. The ink reservoir according to claim 3, wherein each fiber layer has a maximum thickness corresponding to the diameter of three fibers.

5. The ink reservoir according to claim 1, wherein at least some of the fibers are polyethylene polypropylene fibers.

6. The ink reservoir according to claim 1, further comprising a filter, the filter being situated between the fibrous member and the duct.

7. The ink reservoir according to claim 6, wherein the filter comprises a mesh made of strands.

8. The ink reservoir according to claim 7, wherein the strands are made of metal.

9. The ink reservoir according to claim 1, wherein the adjustment member comprises a compressible foam.

10. The ink reservoir according to claim 1, wherein the volume of the adjustment member in relation to the fibrous member is less than 10%.

11. The ink reservoir according to claim 1, wherein the adjustment member extends along the a complete face side of the fibrous member directed towards the duct.

12. The ink reservoir according to claim 1, further comprising a venting port.

13. The ink reservoir according to claim 1, wherein the fibrous member is for solvent-based ink, which includes at least one solvent selected from the group consisting of alcohols, ketones, sulfoxides, amides, and xylenes.

14. An inkjet cartridge comprising an ink jet reservoir according to claim 1.

15. (canceled)

16. The ink reservoir according to claim 2, wherein the fibrous member provides at least 80% of the ink reservoir for solvent-based ink.

17. The ink reservoir according to claim 4, wherein each fiber layer has a maximum thickness corresponding to the diameter of two fibers.

18. The ink reservoir according to claim 5, wherein at least some of the fibers are polyethylene polypropylene fibers, the polyethylene forming an outer sheath and the polypropylene forming an inner core.

19. The ink reservoir according to claim 10, wherein the volume of the adjustment member in relation to the fibrous member is less than 5%.

20. The ink reservoir according to claim 13, wherein the alcohols are selected from Ethanol and Isopropyl alcohol, the ketones are selected from methyl isobutyl ketone and methyl ethyl ketone, the sulfoxides are dimethyl sulfoxide, and the amides are dimethylformamide.
